(19) United States
(12) Patent Application Publication
(10) Pub. No.: US 2024/0354669 A1
(43) Pub. Date: Oct. 24, 2024

(54) WORK MACHINE WITH OPERATOR FATIGUE MITIGATION SYSTEM

(71) Applicant: Caterpillar Inc., Peoria, IL (US)

(72) Inventors: Mark Howard BANHAM, Victoris Point (AU); Greg DAVIS, Wakerley (AU)

(73) Assignee: Caterpillar Inc., Peoria, IL (US)

(21) Appl. No.: 18/137,736

(22) Filed: Apr. 21, 2023

(51) Int. Cl. G06Q 10/0631

(52) U.S. Cl. CPC G06Q 10/06311

(57) ABSTRACT

A system for mitigating operation of a machine if operator fatigue is detected, the system comprising: a sensor system adapted to capture data corresponding to the operator and the machine; and an operator scheduling system adapted to track a location of the machine, assign an operator to the machine, schedule one or more breaks at pre-set default intervals, receive the data, detect if fatigue is being experienced by the operator based on a predefined criteria being met, calculate an amount of fatigue currently experienced by the operator based on the data, determine that the amount of fatigue currently experienced by the operator is greater than a threshold, advance at least one of the one or more breaks in response to the determination that the amount of fatigue is greater than the threshold, and control one of the operator or the machine based on the threshold.

### TECHNICAL FIELD

The present disclosure generally relates to mobile machines, and more particularly relates to systems for detecting and preventing fatigue in operators of mobile machines.

### BACKGROUND

Mobile machines may be used in the mining industry to transport materials and personnel. These mobile machines are often large in size, and require an operator, e.g., a driver to manually operate the machine in order for the machine to perform its designated/intended operations. Any fatigue and drowsiness on the part of the operator can negatively affect various types of operational performance associate with the machine, e.g., maneuvering, or controlling movement of the machine to a set location, maneuvering a work implement of the machine relative to a frame of the machine or other types of operational machines. Operators that are fatigued may cause increased operational costs and may cause issues relating to safety both to the machines and to themselves. Generally, an operator is encouraged to stop the machine and take a break when feeling tired or drowsy in order to operate the machine normally.

In addition, the operator may mistakenly, or inadvertently, develop a false sense of confidence on his/her physical condition and continue to operate even though fatigued. This overconfidence may be due to the operator being familiar with the destination point, knowing a scheduled break point is fast approaching, and desiring to deliver material or personnel to the destination point as soon as possible.

Such machines may be owned by a fleet owner, that may own a plurality of machines and employ a large number of operators. From an operational management viewpoint, the fleet owner often desires to manage the operating situation of each operator. Devices are known in the art that have been developed for the purpose of keeping the operator awake by issuing a warning sound in each machine at predetermined times.

Other systems and methods have been employed to monitor the physical condition of operators of heavy machinery. U.S. Publication 2021/0039653 discloses a management system for monitoring the condition and operation conditions of an operator operating a machine. The management system may include a first monitoring device for monitoring a travel state of a target machine, a second monitoring device for monitoring a physical state during operating of an operator, a server, and a manager terminal. In addition, the system may provide a warning to the operator if operating conditions deviate from a normal condition. The system assists to alleviate a workload backlog for a manager managing a large number of operators.

In light of the aforementioned shortcomings, there is a need for a system to integrate and manage the break schedule for operators of heavy machinery upon the sensing of fatigue within the operator.

### SUMMARY

In accordance with one aspect of the disclosure, a machine may be provided. The machine may have a frame, a drivetrain supported by the frame, a cabin supported by the frame, and system for mitigating operation of a machine if operator fatigue is detected, provided in the cabin. The machine may include a sensor system adapted to capture data corresponding to the operator and the machine, and an operator scheduling system. The operator scheduling system may be adapted to track a location of the machine, assign an operator to the machine, and schedule one or more breaks at pre-set default intervals. The operator scheduling system may be adapted to receive the data, detect if fatigue is being experienced by the operator based on a predefined criteria being met, calculate an amount of fatigue currently experienced by the operator based on the data. The operator scheduling system may be adapted to determine that the amount of fatigue currently experienced by the operator is greater than a threshold, advance at least one of the one or more breaks in response to the determination that the amount of fatigue is greater than the threshold. The operator scheduling system may also be adapted to control one of the operator or the machine based on the threshold.

In accordance with another aspect of the present disclosure, a system for mitigating operation of a machine if operator fatigue is detected may be provided. The system may include a sensor system adapted to capture data corresponding to the operator and the machine. The system may include an operator scheduling system adapted to track a location of the machine, assign an operator to the machine, and schedule one or more breaks at pre-set default intervals. The operator scheduling system may be adapted to receive the data, detect if fatigue is being experienced by the operator based on a predefined criteria being met, calculate an amount of fatigue currently experienced by the operator based on the data. The operator scheduling system may be adapted to determine that the amount of fatigue currently experienced by the operator is greater than a threshold, advance at least one of the one or more breaks in response to the determination that the amount of fatigue is greater than the threshold. The operator scheduling system may also be adapted to control one of the operator or the machine based on the threshold.

In accordance with yet another aspect of the present disclosure, a method of reducing operator fatigue is provided. The method may comprise monitoring a face of an operator of a machine with an operator tracking sensor system and generating operator data. The method may further comprise tracking operation conditions of the machine with a machine monitoring sensor and generating machine data. The method may further comprise compiling the operator data and the machine data through a machine interface. The method may further comprise transmitting the operator data and the machine data from the machine interface to an operator scheduling system. The method may further comprise detecting if fatigue is currently being experience by the operator based on the operator data and the machine data. The method may further comprise calculating an amount of fatigue currently experienced by the operator based on the operator data and the machine data. The method may further comprise determining that the amount of fatigue currently experience by the operator is greater than a threshold. The method may further comprise advancing one or more breaks for the operator in response to a determination that the amount of fatigue is greater than the threshold. The method may also comprise controlling one of the operator or machine based on the threshold.

These and other aspects and features of the present disclosure will be more readily understood when read in conjunction with the accompanying drawings.

### BRIEF DESCRIPTION OF THE DRAWINGS

FIG. 1 is a perspective view of a machine in accordance with an embodiment of the present disclosure.

FIG. 2 is a block diagram schematically illustrating a fatigue mitigation system of the machine of in accordance with an embodiment of the present disclosure.

FIG. 3 is a block diagram of a scheduling system for reducing operator fatigue in accordance with an embodiment of the present disclosure.

FIG. 4 is an exemplary flowchart depicting a method of reducing operator fatigue, in accordance with an embodiment of the present disclosure.

### DETAILED DESCRIPTION

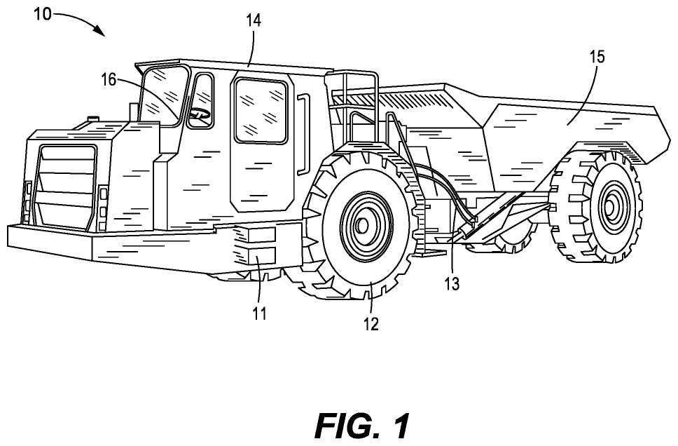

Referring now to the drawings, and with specific reference to FIG. 1, a machine is depicted and generally referred to using reference numeral ‘10’. The machine 10 is exemplarily embodied in the form of an underground mining truck. While the machine 10 is depicted as a mining truck, it should be noted that a type of machine used is merely exemplary and illustrative in nature. It will be acknowledged that the teachings of the present disclosure can be similarly applied to other types of machines including but not limited to, excavators, loaders, track-type tractors, motor graders, off highway trucks and other types of machines known to persons skilled in the art.

Mining machines are used to transport materials between mining sites. The exemplary machine 10 is formed by a frame 11. The machine 10 may include a drivetrain 12 contacting the ground and supporting the frame 11 in order to operate the machine 10, and may include an engine 13 to power the machine and provide energy to the drivetrain 12. The machine 10 may also include an implement 15 to perform a work job. In the view of FIG. 1, the implement 15 is exemplarily depicted as a dump body, but may be other types of work implements known to persons skilled in the art. The machine 10 may also include an operator cabin 14 with an operator fatigue mitigation system 16 provided in the operator cabin 14 to prevent an operator (not shown) of the machine 10 from operating the machine while fatigued.

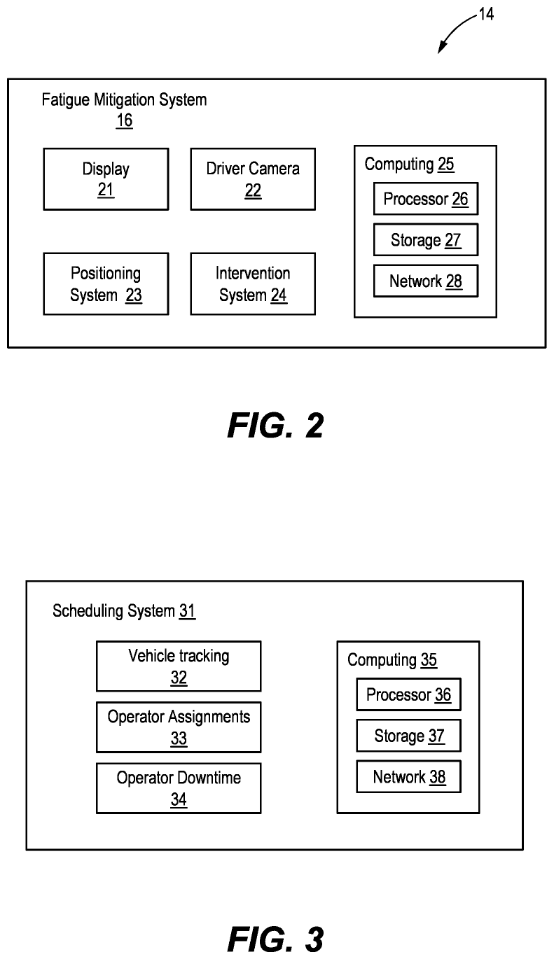

A representation of the operator fatigue mitigation system 16 is shown schematically in FIG. 2. The operator fatigue mitigation system 16 may include a machine interface 20 formed by a display 21, a camera 22, a positioning system 23, an intervention system 24, and a computing system 25. The machine interface 20 may be customized to individual operators when a new operator starts a shift of operating the machine. The machine interface 20 may also be configured to be automatically reset, either when the machine is powered off and subsequently powered on again, or at the end and start of subsequent work shifts.

The camera 22 may be a dedicated operator-facing sensor to be aimed at the operator's face, however, other face tracking sensors as known may be implemented. The camera 22 looks for instances of distraction—for instance when the operator is looking away from the road at passing distraction, or at a mobile phone—closed eyelids, and other instances of microsleep such as, but not limited to, nodding of the operator's head, reduced or no response to auditory or visual cues, pupil dilation, and change in heart rate. The camera 22 may look for changes in blink rates such as a few blinks with long intervals between blinks, or multiple rapid shot blinks such as saccades. The camera 22 may also be equipped with night vision such that tracking may be accomplished in poorly lit environments. The operator fatigue mitigation system 16 may also include a microphone to record audio data of the operator, and the microphone may be implemented with or without the camera 22.

The positioning system 23 tracks the operation of the machine 10 and monitors the location and way-points along a route of travel for the machine 10. An exemplary form of the positioning system 23 may be a global positioning sensor (GPS), but other variations may be implemented. The positioning system 23 may be configured to track the movement of the machine 10, for instance, machine speed, and machine path. In conditions where an operator may be fatigued, the operator may arbitrarily modulate the speed of the machine, an implement of the machine, and/or may haphazardly cause a steering system to change a steering angle of the wheels relative to the frame 11 of the machine 10.

The intervention system 24 may be configured to provide instantaneous feedback to the operator. For example, the intervention system 24 may include video, haptic and audio alerts to instantaneously notify the operator, or provide a warning to the operator, that their operation of the machine 10 may become erratic. The intervention system 24 may also include sensors on the operator controls such as within a steering wheel. The sensors within the steering wheel may be configured to sense grip pressure from the operator.

The computing system 25 may include a processor 26, a storage medium 27, and a networking interface 28. The computing system 25 may be configured to receive face tracking data from the camera 22 and machine sensor data from the positioning system 23. The computing system 25 may also be configured to store the face tracking data and the machine sensor data on the storage medium 27.

The networking interface 28 may be configured to transmit the combined face tracking data and machine sensor data to an operator scheduling system 31. The operator scheduling system 31 may be remotely located from the machine 10 and at a central worksite management office.

The operator scheduling system 31 may include a machine tracking operation 32 for monitoring a fleet of machines owned by a fleet owner. The machine tracking operation 32 may monitor the locations of individual machines within the fleet, those machines within the fleet that are in operation, and may monitor health of individual machines in the fleet such as repair and maintenance schedules. The operator scheduling system 31 may also include an operator assignment operation 33 for assigning operators to individual machines to perform certain jobs. Among other functions, the operator assignment operation 33 may manage operator shifts, and individual machine assignments. The operator scheduling system 31 may also include an operator downtime operation 34 for scheduling break times for the individual operators.

The operator scheduling system 31 may also include a computing system 35 of its own configured with a processor 36, a storage medium 37, and a networking interface 38. The computing system 35 may be configured to manage the machine tracking operation 32, the operator assignment operation 33, and the operator downtime operation 34.

In the operation of the machine 10, the computing system 35 of the operator scheduling system 31 may be configured to receive data as sensed by the camera 22 and the positioning system 23 of the operator fatigue mitigation system 16. The operator scheduling system 31 may be configured to store the data on storage medium 37, which may be a server, among other forms of non-transitory storage mediums. The storage medium 37, may include models for determining an amount of operator fatigue, and the computing system 35 may be configured to reference the models and compute an amount of fatigue for the operator using the transmitted data.

The computing system 35 may further be configured to determine if the computed amount of fatigue is greater than a threshold, and if so, may reference an individual operator's assignment schedule and break schedule via the operator assignment operation 33, and the operator downtime operation 34. The operator scheduling system 31 may then modify an upcoming break via the operator downtime operation 34. The operator downtime operation 34 may have the capability to schedule an immediate break, bring up a break that is due, re-shuffle breaks between a crew of operators, or put individual operators on shorter operation intervals, among other scheduling operations. The operator downtime operation 34 may be configured to recognize a route that the machine is currently on, and schedule an upcoming break once the machine reaches the destination of the route that the machine is currently on, or prior to the start of a subsequent route. The operator scheduling system 31 may also be configured to be a continuously learning system.

The operator fatigue mitigation system 16 may be configured to include intervention systems that are configured to interfere with the normal operation of the machine 10. After modifying a break for the operator, and once that break has been completed, the operator may still exhibit signs of fatigue such that the operator fatigue mitigation system 16 continues to sense fatigue the computing system 35 continues to calculate an amount of fatigue over the threshold. In this case, the operator fatigue mitigation system 16 may be configured to lower the power rating of the machine, either logarithmically, or linearly. The operator fatigue mitigation system 16 may activate the intervention system 24 in such a manner that the operator is required to interact with the display 21 or physical controls such as buttons located in close proximity to the operator in order to deactivate the intervention system. The computing system 25 may record, store, and transmit instances of activations of the intervention system 24 in this manner to the computing system 35 of the operator scheduling system 31.

### Industrial Applicability

In operation, the teachings of the present disclosure can find applicability in many industries including but not limited to machines used in the earth moving, mining, agricultural, and construction industries. While depicted and described in conjunction with a mining machine, such teachings, can also find applicability with other machines such as loaders, track-type tractors, motor graders, off highway trucks, and the like.

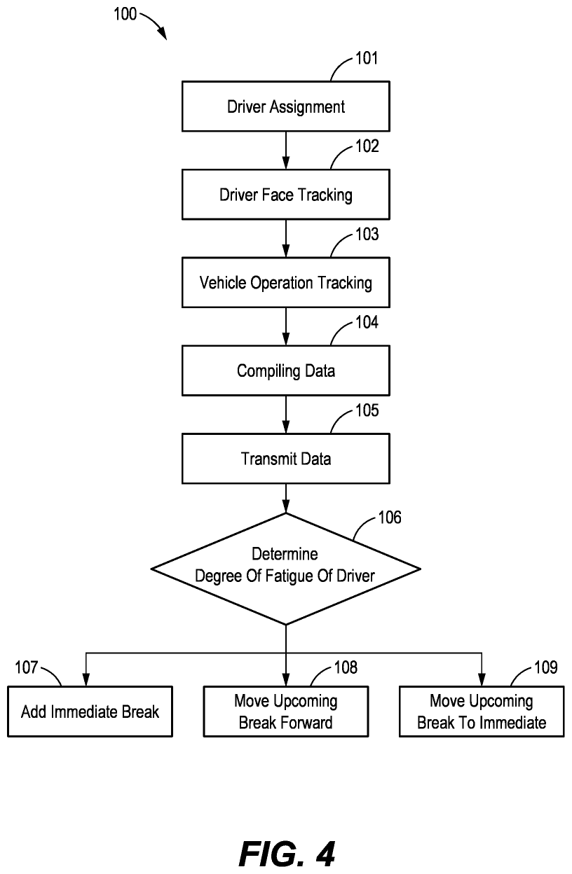

FIG. 4 illustrates a visual representation of a method 100 of reducing operator fatigue of the machine 10. In a first step 101, the operator scheduling system 31 tracks the location, schedule, and routes a fleet of machines 10, assigning an operator to the machine 10 to perform a job, and assigning the operator a scheduled break via the operator downtime operation 34.

In a second step 102, an operator tracking sensor system in the form of the camera 22 tracks the operator's face while in operation of the machine 10 and generates operator data through computing system 25.

In a third step 103, a machine monitoring sensor in the form of the positioning system 23 tracks the operation conditions of the machine 10 and generates machine data through computing system 25.

In a fourth step 104, the computing system 25 compiles the operator data and the machine data and stores it on storage medium 27.

In a fifth step 105, the networking interface 28 of the computing system 25 of the machine 10 transmits the operator data and the machine data to the operator scheduling system 31 through the networking interface 38 of the computing system 35 of the operator scheduling system 31.

In a sixth step 106, the computing system 35 of the operator scheduling system 31 detects if fatigue is currently being experienced by the operator by evaluating the operator data and the machine data. The computing system 35 then calculates an amount of fatigue of the operator based on the operator data and the machine data. The computing system 35 may reference machine learning model data stored on storage medium 37 in order to calculate the amount of fatigue.

In a seventh step 107, if the computing system 35 of the operator scheduling system 31 determines that the amount of fatigue is over a threshold, the operator downtime operation 34 may add an additional immediate break to the operator's break schedule.

In an eighth step 108, if the computing system 35 of the operator scheduling system 31 determines that the amount of fatigue is over a threshold, the operator downtime operation 34 may move an upcoming scheduled break slightly forward in time.

Finally, in a ninth step 109, if the computing system 35 of the operator scheduling system 31 determines that the amount of fatigue is over a threshold, the operator downtime operation 34 may move an upcoming scheduled break to an immediate point in time.

The method of reducing operator fatigue 100 describes operation of the machine 10 and the operator scheduling system 31 of the primary embodiment, and how in operation, the operator fatigue mitigation system 16 may determine the overall alertness of an operator of a machine. By determining how fatigued, if at all, an operator is, the system may either subtly suggest the operator to take a break, or may schedule an immediate break for the individual operator. The operator fatigue mitigation system 16 may be easy to implement and retrofit, and may further prevent accidental damage to machines in a fleet owned by a fleet owner caused by operators who are fatigued.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A machine comprising:
a frame;
a drivetrain supported by the frame;
a cabin supported by the frame;
a system for mitigating operation of a machine if operator fatigue is detected, provided in the cabin, the system including:
a sensor system adapted to capture data corresponding to the operator and the machine; and
an operator scheduling system adapted to track a location of the machine, assign an operator to the machine, schedule one or more breaks at pre-set default intervals, receive the data, detect if fatigue is being experienced by the operator based on a predefined criteria being met, calculate an amount of fatigue currently experienced by the operator based on the data, determine that the amount of fatigue currently experienced by the operator is greater than a threshold, advance at least one of the one or more breaks in response to the determination that the amount of fatigue is greater than the threshold, and control one of the operator or the machine based on the threshold.

2. The machine of claim 1, wherein the data corresponding to the operator and the machine includes at least one of: operator head pose, body attitude, facial features, and operating characteristics of the operator.

3. The machine of claim 1 further comprising a server in communication with the sensor system, the server configured to store data captured by and received from the sensor system.

4. The machine of claim 1, wherein the sensor system includes at least one of camera, a microphone, a wheel speed sensor, a ground speed sensor, and a position detection system.

5. The machine of claim 1, wherein a machine learning model is used to detect fatigue in the operator, calculate the amount of fatigue currently experienced by the operator, and set the threshold.

6. The machine of claim 1, wherein the operator scheduling system progressively advances the one or more breaks commensurate with either a time to fatigue or a level of fatigue.

7. The machine of claim 1, wherein the system controls one of the operator or the machine by intervening with the machine if, after a break modification is made, the system detects that the amount of fatigue remains greater than the threshold, the system either decreases the power rating of the machine or requires the operator to interact with the system components provided in the cabin.

8. A system for mitigating operation of a machine if operator fatigue is detected, the system comprising:
a sensor system adapted to capture data corresponding to the operator and the machine; and
an operator scheduling system adapted to track a location of the machine, assign an operator to the machine, schedule one or more breaks at pre-set default intervals, receive the data, detect if fatigue is being experienced by the operator based on a predefined criteria being met, calculate an amount of fatigue currently experienced by the operator based on the data, determine that the amount of fatigue currently experienced by the operator is greater than a threshold, advance at least one of the one or more breaks in response to the determination that the amount of fatigue is greater than the threshold, and control one of the operator or the machine based on the threshold.

9. The system of claim 8, wherein the data corresponding to the operator and the machine includes at least one of: operator head pose, body attitude, facial features, and operating characteristics of the operator.

10. The system of claim 8 further comprising a server in communication with the sensor system, the server configured to store data captured by and received from the sensor system.

11. The system of claim 8, wherein the sensor system includes at least one of a camera, a microphone, a wheel speed sensor, a ground speed sensor, and a position detection system.

12. The system of claim 8, wherein a machine learning model is used to detect fatigue in the operator, calculate the amount of fatigue currently experienced by the operator, and set the threshold.

13. The system of claim 8, wherein the operator scheduling system progressively advances the one or more breaks commensurate with either a time to fatigue or a level of fatigue.

14. The system of claim 8, wherein the system controls one of the operator or the machine by intervening with the machine if, after a break modification is made, the system detects that the amount of fatigue remains greater than the threshold, the system either decreases the power rating of the machine or requires the operator to interact with the system components provided in the cabin.

15. A method of reducing machine operator fatigue, comprising:
monitoring a face of an operator of a machine with a sensor system and generating operator data;
tracking operation conditions of the machine with the sensor system and generating machine data;
compiling the operator data and the machine data through a machine interface;
transmitting data from the machine interface to an operator scheduling system;
detecting if fatigue is currently being experience by the operator based on the data;
calculating an amount of fatigue currently experienced by the operator;
determining that the amount of fatigue currently experienced by the operator is greater than a threshold;
advancing one or more breaks for the operator in response to a determination that the amount of fatigue is greater than the threshold; and
controlling one of the operator or machine based on the threshold.

16. The method of claim 15 further comprising storing the operator data and the machine data on a server of the operator scheduling system.

17. The method of claim 15, wherein the monitoring is performed using a camera, and the operator data includes video data.

18. The method of claim 15, wherein the monitoring is performed using a microphone, and the operator data includes audio data.

19. The method of claim 15, wherein the tracking is performed using a positioning system.

20. The method of claim 15, wherein in the controlling step, if, after a break modification is made, the system detects that the amount of fatigue remains greater than the threshold, the system either decreases the power rating of the machine or requires the operator to interact with the system components provided in the cabin.
